(19) United States
(12) Patent Application Publication
(10) Pub. No.: US 2019/0155108 A1
(43) Pub. Date: May 23, 2019

(54) OPTICAL ALIGNMENT APPARATUS

(71) Applicant: SHENZHEN CHINA STAR OPTOELECTRONICS TECHNOLOGY CO., LTD., Shenzhen, Guangdong (CN)

(72) Inventors: Yongchao ZHAO, Shenzhen, Guangdong (CN); Chungching HSIEH, Shenzhen, Guangdong (CN)

(73) Assignee: SHENZHEN CHINA STAR OPTOELECTRONICS TECHNOLOGY CO., LTD., Shenzhen, Guangdong (CN)

(21) Appl. No.: 15/329,483

(22) PCT Filed: Jan. 20, 2017
(86) PCT No.: PCT/CN2017/071909

§ 371 Date: Jan. 26, 2017

(30) Foreign Application Priority Data
Dec. 28, 2016 (CN) 201611238324.4

(51) Int. Cl. G02F 1/1337; G02F 1/1335; G02F 1/139

(52) U.S. Cl. CPC G02F 1/133788; G02F 1/133711; G02F 1/1396; G02F 1/133753; G02F 1/133528

(57) ABSTRACT

An optical alignment apparatus is provided. The optical alignment includes a machine table and an alignment light source, a polarizer and a twisted nematic liquid crystal display for regulating the polarization direction of the alignment light. The advantage of the optical alignment apparatus of the present invention is that the polarization direction of the alignment light can be adjusted according to the alignment requirements, so that the alignment films having the different alignment requirements can be aligned without rotating the substrate.

### FIELD OF THE INVENTION

The present invention relates to the field of optical alignment of liquid crystal display panels, and to an optical alignment apparatus.

### BACKGROUND OF THE INVENTION

Most of the conventional liquid crystal displays are a backlight type liquid crystal display, which includes a housing, a liquid crystal panel disposed in the housing, and a backlight module disposed in the housing. Generally, a liquid crystal panel is composed of a color filter (CF) substrate, a thin film transistor array (TFT) substrate, and a liquid crystal layer filled between the two substrates. The working principle thereof is that by applying a driving voltage to the CF substrate and the TFT substrate, the rotation of the liquid crystal molecules of the liquid crystal layer and the light output are controlled to refract the light emitted from the backlight module to generate images.

In the manufacturing process of a liquid crystal display panel, aligning the alignment film is an important process. The liquid crystal molecules arranged in accordance with a specific direction and angle are achieved by the alignment process. In the TFT-LCD production, there are two alignment methods: friction alignment and optical alignment. The friction alignment is a physical method resulting in static electricity and particle contamination. The optical alignment is a non-contact alignment technique, and utilizes a linear polarized light to irradiate the alignment film of high molecular weight polymer, which is sensitive to light, to form the alignment microstructures having a specific tilt angle on the alignment film surface to achieve the alignment effect.

FIG. 1 is a schematic view of a conventional optical alignment machine table. A frame 105 is disposed on the machine table 104. An alignment light source 101 is disposed on the bracket 105. The frame 105 is provided with an alignment light source 101, and a linear polarized light having a fixed polarization direction is obtained from the alignment light source 101 through a filter 102 and a polarizer 103. Since the polarization direction of the linear polarized light determines the alignment direction of the alignment film, the different substrate designs require the different alignment directions of the alignment films. Under the condition that the direction of the linear polarized light cannot be changed, to obtain the different alignment directions, a solution thereof is to rotate the substrate 106 to have the long side of the glass substrate to be scanned by irradiation of light or the short side of the glass substrate to be scanned by irradiation of light. When it is the long side of the glass substrate that the light enters the glass substrate, then it is needed to increase the size of the alignment light source 101, the filter 102, the polarizer 103, and the machine table, thus increasing the cost.

Therefore, there is a need to provide a novel optical alignment apparatus capable of aligning the alignment films of different types of liquid crystal display panels without increasing the size of each component.

### SUMMARY OF THE INVENTION

The present invention provides an optical alignment apparatus capable of aligning the alignment films of different types of liquid crystal display panels without changing the sizes of components to solve the problem that before the substrates having different alignment requirements enter the alignment apparatus, it is required to rotate the substrates, the entrance of the substrates into the apparatus with the long side requires increasing the sizes of the machine table and the components, thereby increasing the cost of the apparatus.

To resolve the aforementioned problem, the present invention provides the technical solution as follows:

The present invention provides an optical alignment apparatus, comprising:

a machine table on which a to-be-aligned substrate is conveyed, and above which the machine table is provided with:

an alignment light source for emitting alignment light;

a polarizer positioned below the alignment light source so that incident light is transformed into polarized light and is emitted;

a twisted nematic liquid crystal display positioned below the polarizer for controlling a polarization direction of transmitted light, wherein the twisted nematic liquid crystal display includes:

an upper substrate provided with a common electrode layer on a lower surface of upper substrate;

a lower substrate disposed opposite the upper substrate, wherein an upper surface of the lower substrate is provided with a thin film transistor array and a pixel electrode layer; and

a liquid crystal layer sandwiched between the upper substrate and the lower substrate;

a light-guiding plate horizontally disposed, wherein a side of the light-guiding plate is a light-entry surface, a light-emitting surface of the alignment light source is disposed close to the light-entry surface of the light-guiding plate, a lower surface of the light-guiding plate is a light-exit surface, and a light-exit surface is positioned above the polarizer and parallel to the polarizer.

In a preferred embodiment of the present invention, a lower surface of the upper substrate is provided with an upper alignment film, and an upper surface of the lower substrate is provided with a lower alignment film, an alignment groove on a surface of the upper alignment film is perpendicular to an alignment groove on a surface of the lower alignment film, and the liquid crystal layer is positioned between the upper alignment film and the lower alignment film.

In a preferred embodiment of the present invention, when no voltage is applied to the twisted nematic liquid crystal display, long axes of liquid crystal molecules in the liquid crystal layer are parallel to the upper alignment film and the lower alignment film, and the liquid crystal molecules in a single pixel are longitudinally distributed and gradually rotate to 90 degrees; and when a voltage is applied to the twisted nematic liquid crystal display, the long axes of the liquid crystal molecules in the liquid crystal layer are perpendicular to the upper alignment film and the lower alignment film.

In a preferred embodiment of the present invention, the optical alignment apparatus further comprises a filter beneath the alignment light source for filtering out light of a specified wavelength according to actual needs.

In a preferred embodiment of the present invention, the filter is used for filtering out ultraviolet light of a wavelength except for ultraviolet light of a wavelength from 240 to 370 nm.

In a preferred embodiment of the present invention, the machine table is positioned below the twisted nematic liquid crystal display, and a glass substrate coated with a polyimide liquid is transferred on the machine table.

In a preferred embodiment of the present invention, a reflective sheet is attached onto an upper surface of the light-guiding plate.

In a preferred embodiment of the present invention, the alignment light source is a microwave ultraviolet lamp.

In a preferred embodiment of the present invention, power of the microwave ultraviolet lamp is at least 900 MHz.

The present invention also provides an optical alignment apparatus, comprising:

a machine table on which a to-be-aligned substrate is conveyed, and above which the machine table is provided with:

an alignment light source for emitting alignment light;

a polarizer positioned below the alignment light source so that incident light is transformed into polarized light and is emitted;

a twisted nematic liquid crystal display positioned below the polarizer for controlling a polarization direction of transmitted light, wherein the twisted nematic liquid crystal display includes:

an upper substrate provided with a common electrode layer on a lower surface of the upper substrate;

a lower substrate disposed opposite the upper substrate, wherein an upper surface of the lower substrate is provided with a thin film transistor array and a pixel electrode layer; and

a liquid crystal layer sandwiched between the upper substrate and the lower substrate.

In a preferred embodiment of the present invention, a lower surface of the upper substrate is provided with an upper alignment film, and an upper surface of the lower substrate is provided with a lower alignment film, an alignment groove on a surface of the upper alignment film is perpendicular to an alignment groove on a surface of the lower alignment film, and the liquid crystal layer is positioned between the upper alignment film and the lower alignment film.

In a preferred embodiment of the present invention, when no voltage is applied to the twisted nematic liquid crystal display, long axes of liquid crystal molecules in the liquid crystal layer are parallel to the upper alignment film and the lower alignment film, and the liquid crystal molecules in a single pixel are longitudinally distributed and gradually rotate to 90 degrees; and

when a voltage is applied to the twisted nematic liquid crystal display, the long axes of the liquid crystal molecules in the liquid crystal layer are perpendicular to the upper alignment film and the lower alignment film.

In a preferred embodiment of the present invention, the optical alignment apparatus further comprises a filter beneath the alignment light source for filtering out light of a specified wavelength according to actual needs.

In a preferred embodiment of the present invention, the filter is used for filtering out ultraviolet light of a wavelength except for ultraviolet light of a wavelength from 240 to 370 nm.

In a preferred embodiment of the present invention, the machine table is positioned below the twisted nematic liquid crystal display, and a glass substrate coated with a polyimide liquid is transferred on the machine table.

In a preferred embodiment of the present invention, the alignment light source is a microwave ultraviolet lamp.

In a preferred embodiment of the present invention, power of the microwave ultraviolet lamp is at least 900 MHz.

The advantage of the present invention is that compared with the conventional optical alignment apparatus, the polarization direction of the alignment light is adjustable according to different alignment requirements so as to align the alignment films having the different alignment requirements without rotating the substrate. The technical problem is resolved that in the optical alignment apparatus in the prior art, the compatibility is low, the alignment light is not adjustable, and when the substrates having the different alignment requirements enter the apparatus, it is required to rotate the substrates by 90 degrees for entering the apparatus with the long side, so that the sizes of the machine table and the components need to be increased for satisfying the optical alignment requirements of the substrates, thereby increasing the cost of the apparatus.

### BRIEF DESCRIPTION OF THE DRAWINGS

In order to more clearly illustrate the embodiments of the present invention or the technical solutions in prior arts, the following briefly introduces the accompanying drawings used in the embodiments. Obviously, the drawings in the following description merely show some of the embodiments of the present invention. As regards one of ordinary skill in the art, other drawings can be obtained in accordance with these accompanying drawings without making creative efforts.

FIG. 1 is a structural schematic diagram of a conventional optical alignment apparatus.

FIG. 2 is a structural schematic diagram of an optical alignment apparatus in accordance with the present invention.

FIG. 3 is an enlarged schematic view of the twisted nematic liquid crystal display in FIG. 2.

FIG. 4 shows the behavior of the liquid crystal molecules in the non-energized state in the twisted nematic liquid crystal display of FIG. 3.

FIG. 5 shows the behavior of the liquid crystal molecules in the energized state in the twisted nematic liquid crystal display of FIG. 3.

### DETAILED DESCRIPTION OF THE PREFERRED EMBODIMENTS

The following description of the embodiments with reference to the accompanying drawings is used to illustrate particular embodiments of the present invention. The directional terms referred in the present invention, such as “upper”, “lower”, “front”, “back”, “left”, “right”, “inner”, “outer”, “side”, etc. are only directions with regard to the accompanying drawings. Therefore, the directional terms used for describing and illustrating the present invention are not intended to limit the present invention.

The present invention aims to resolve the technical problem that in the optical alignment apparatus in the prior art, the compatibility is low, the alignment light is not adjustable, and when the substrates having the different alignment requirements enter the apparatus, it is required to rotate the substrates by 90 degrees for entering the apparatus with the long side, so that the sizes of the machine table and the components need to be increased for satisfying the optical alignment requirements of the substrates, thereby increasing the cost of the apparatus. The present embodiment can improve the defects.

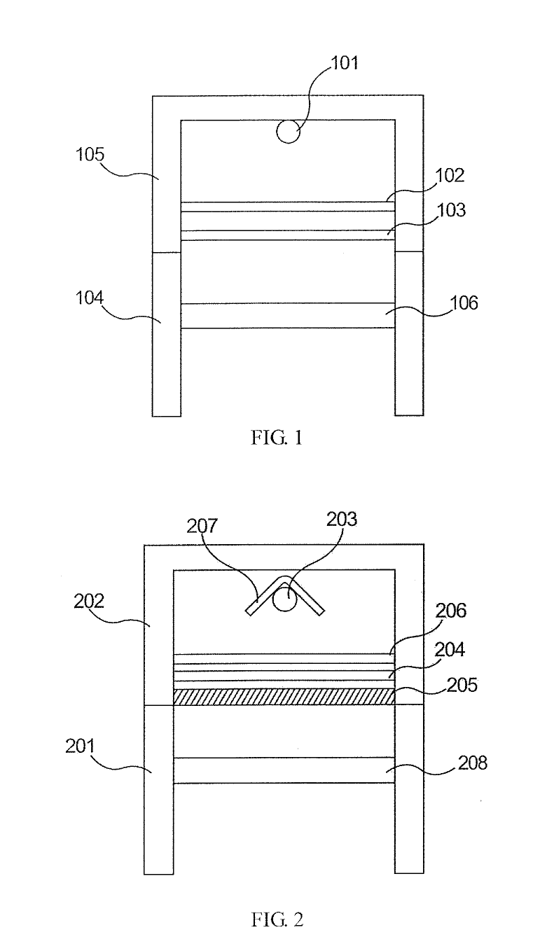

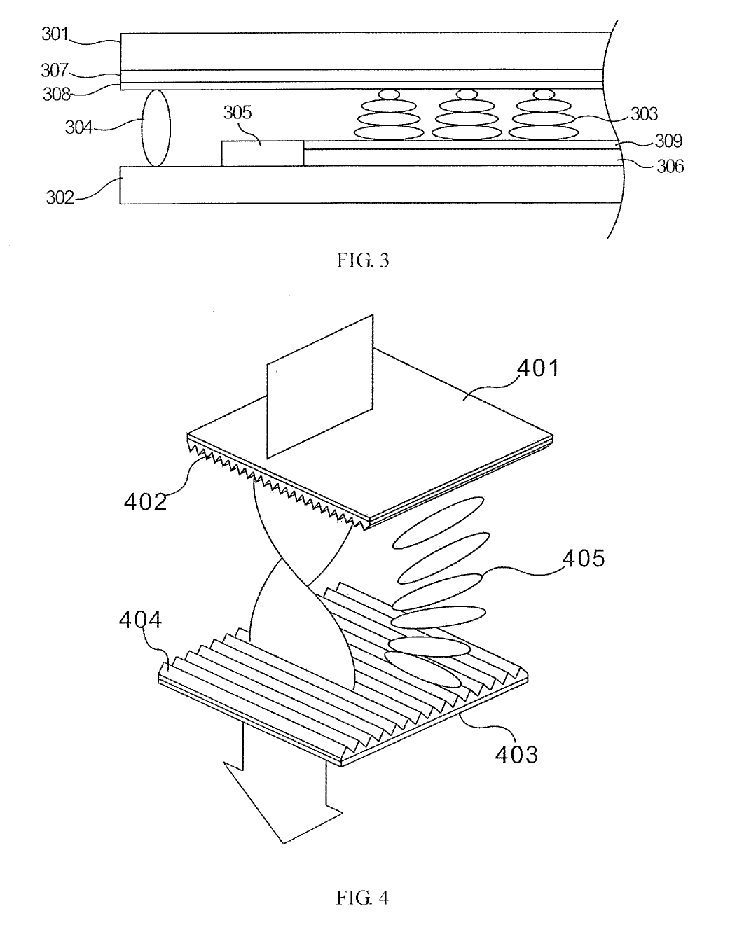

As shown in FIG. 2, the optical alignment apparatus of the present invention includes a machine table 201 in which a conveyance part and a clamping part are disposed. The holding part is fixedly connected to the conveyance section. A to-be-aligned substrate 208 enters the entrance of the machine table 201, one side of the to-be-aligned substrate 208 is clamped and held by the clamping part, and then the to-be-aligned substrate 208 is delivered via the conveyance part to a place below the alignment light source, and finally the completely-aligned substrate is delivered to the next process.

The to-be-aligned substrate 208 is an array substrate or a color film substrate of a liquid crystal display panel, and the surface of each of the array substrate and the color film substrate is provided with an alignment film. Before the to-be-aligned substrate 208 enters the optical alignment apparatus, the surface of the alignment film is coated with a sensitizer for reacting with the alignment light to realize the alignment. In some types of liquid crystal display panels, there is a 90 degree direction difference between alignment grooves positioned on the surface of the alignment film on the array substrate and alignment grooves positioned on the surface of the alignment film on the color film substrate (orthogonally), so that it is required to rotate the substrate by 90 degrees during the alignment process whereby the substrate can receive the scanning irradiation in the correct direction.

An upper part of the machine table 201 is provided with a frame 202. An alignment light source 203, a polarizer 204, and a twisted nematic liquid crystal display 205 (TN-LCD) are disposed on a frame 202. The alignment light source 203 is a microwave ultraviolet lamp for emitting alignment light. The alignment light source 203 is positioned on the upper part of the frame 202. The polarizer 204 is positioned below the alignment light source 203 so that incident light is transformed to polarized light and is emitted. The twisted nematic liquid crystal display 205 is positioned below the polarizer 204 for controlling the polarization direction of the transmitted light.

Preferably, a filter 206 is disposed between the alignment light source 203 and the polarizer 204. The filter 206 is used for filtering out unwanted light, and leaving light of a specified wavelength to match the actual alignment needs. For example, the filter 206 is used for filtering out ultraviolet light except for ultraviolet light of a wavelength from 240 to 370 nm.

Preferably, a lamp cover 207 is disposed outside the alignment light source 203 to expand the irradiation range and to uniformly distribute the light. For another example, the optical alignment apparatus further includes a light-guiding plate horizontally disposed. A side of the light-guiding plate is a light-entry surface, a light-emitting surface of the alignment light source 203 is disposed close to the light-entry surface of the light-guiding plate, a lower surface of the light-guiding plate is a light-exit surface, and a light-exit surface is positioned above the polarizer and parallel to the polarizer. The light-guiding plate causes the light emitted from the alignment light source 203 to be evenly distributed for fully utilizing the alignment light.

Preferably, the upper surface of the light-guiding plate is provided with a reflecting film for reflecting the alignment light down to the polarizer.

Refer to FIG. 3, which is an enlarged schematic view of the twisted nematic liquid crystal display in FIG. 2. The twisted nematic liquid crystal display includes an upper substrate 301 and a lower substrate 302. The upper substrate 301 and the lower substrate 302 are disposed opposite each other. A liquid crystal layer 303 is disposed between the upper substrate 301 and the lower substrate 302. A plastic frame 304 is disposed outside the liquid crystal layer 303. The polarizer is not disposed below the twisted nematic liquid crystal display. The surface of the upper substrate 301 provided with a common electrode layer. The surface of the lower substrate is provided with a plurality of thin film transistor arrays 305 and a pixel electrode layer 306. A voltage is applied between the pixel electrode layer 306 and the common electrode layer 307 to alter the status of the liquid crystal layer 303, thereby controlling the light transmission rate.

In the twisted nematic liquid crystal display, the lower surface of the upper substrate 301 is provided with an upper alignment film 308, and the upper surface of the lower substrate 302 is provided with a lower alignment film 309. According to the characteristics of the twisted nematic liquid crystal display, the direction of the alignment groove on the surface of the upper alignment film 308 is perpendicular to the direction of the alignment groove on the surface of the lower alignment film 309, and the liquid crystal layer 303 is positioned between the upper alignment film 308 and the lower alignment film 309.

Refer to FIG. 4, which shows the behavior of the liquid crystal molecules in the non-energized state in the twisted nematic liquid crystal display of FIG. 3. The figure includes a common electrode layer 401, an upper alignment film 402, and a pixel electrode layer 403, which are respectively positioned under and below the lower surface of the common electrode layer 401, and a lower alignment film 404, which is positioned on the upper surface of the pixel electrode layer 403. The liquid crystal molecules 405 in the liquid crystal layer are arranged along the upper alignment film 402 and the lower alignment film 404. The long axes of the uncharged liquid crystal molecules 405 are parallel to the upper substrate and the lower substrate, and the arrangement of the liquid crystal molecules 405 is gradually twisted by 90 degrees from the upper substrate to the lower substrate. The liquid crystal layer is sandwiched between the upper substrate and the lower substrate to form the twisted nematic liquid crystal display. Therefore, the light emitted from the alignment light source goes through the polarizer located therebelow to form polarized light, is incident into the twisted nematic liquid crystal display, is twisted by 90 degrees, and then is emitted.

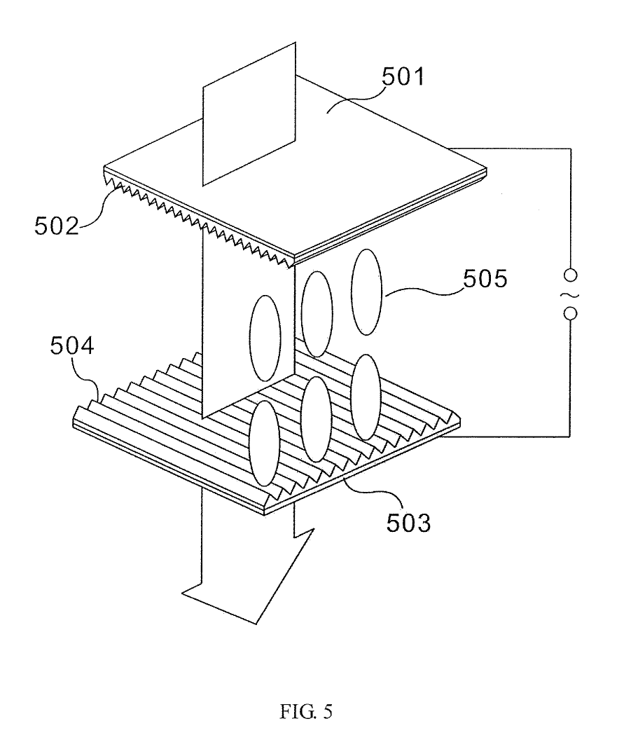

Refer to FIG. 5, which shows the behavior of the liquid crystal molecules in the energized state in the twisted nematic liquid crystal display of FIG. 3. The figure includes a common electrode layer 501, an upper alignment film 502, a pixel electrode layer 503, which are respectively positioned under and below the lower surface of the common electrode layer 501, and a lower alignment film 504, which is positioned on the upper surface of the pixel electrode layer 503. The liquid crystal molecules 505 in the liquid crystal layer are arranged along the upper alignment film 502 and the lower alignment film 504. When a certain voltage is applied between the two electrodes, the long axis of each liquid crystal molecules 505 is rotated by 90 degrees, and is perpendicularly aligned with the upper substrate and the lower substrate. The incident light is transmitted through the polarized light in the liquid crystal cell without being twisted, such that the emitted light remains in the original polarization direction.

The optical alignment apparatus of the present invention utilizes the optical rotation properties of the twisted nematic liquid crystal display. The 90 degree rotation of the long axes of the liquid crystal molecules causes the 90 degree optical rotation. When the voltage is applied, the liquid crystal molecules are arranged in the direction of the electric field, the twisting effect disappears, the optical rotation effect disappears, and the polarization of the transmitted light is not changed. By controlling the two polarization directions of the light, the different alignment requirements of the substrates can be met for optical alignment, it is not required to change the sizes of the machine table and other components, both of the substrates having two alignment requirements can enter the machine table with the short side. It is only required to control the polarization direction of the alignment light for matching the alignment requirements of the different substrates.

In summary, although the preferable embodiments of the present invention have been disclosed above, the embodiments are not intended to limit the present invention. A person of ordinary skill in the art, without departing from the spirit and scope of the present invention, can make various modifications and variations. Therefore, the scope of the invention is defined in the claims.

What is claimed is:

1. An optical alignment apparatus, comprising:
a machine table on which a to-be-aligned substrate is conveyed, and above which is provided with:
an alignment light source for emitting alignment light;
a polarizer positioned below the alignment light source so that incident light is transformed into polarized light and is emitted;
a twisted nematic liquid crystal display positioned below the polarizer for controlling a polarization direction of transmitted light, wherein the twisted nematic liquid crystal display includes:
an upper substrate provided with a common electrode layer on a lower surface of the upper substrate;
a lower substrate disposed opposite the upper substrate, wherein an upper surface of the lower substrate is provided with a thin film transistor array and a pixel electrode layer; and
a liquid crystal layer sandwiched between the upper substrate and the lower substrate;
a light-guiding plate horizontally disposed, wherein a side of the light-guiding plate is a light-entry surface, a light-emitting surface of the alignment light source is disposed close to the light-entry surface of the light-guiding plate, a lower surface of the light-guiding plate is a light-exit surface, and a light-exit surface is positioned above the polarizer and parallel to the polarizer.

2. The optical alignment apparatus as claimed in claim 1, wherein a lower surface of the upper substrate is provided with an upper alignment film, and an upper surface of the lower substrate is provided with a lower alignment film, an alignment groove on a surface of the upper alignment film is perpendicular to an alignment groove on a surface of the lower alignment film, and the liquid crystal layer is positioned between the upper alignment film and the lower alignment film.

3. The optical alignment apparatus as claimed in claim 2, wherein when no voltage is applied to the twisted nematic liquid crystal display, long axes of liquid crystal molecules in the liquid crystal layer are parallel to the upper alignment film and the lower alignment film, and the liquid crystal molecules in a single pixel are longitudinally distributed and rotate to 90 degrees; and
when a voltage is applied to the twisted nematic liquid crystal display, the long axes of the liquid crystal molecules in the liquid crystal layer are perpendicular to the upper alignment film and the lower alignment film.

4. The optical alignment apparatus as claimed in claim 1, further comprising a filter beneath the alignment light source for filtering out light of a specified wavelength according to actual needs.

5. The optical alignment apparatus as claimed in claim 1, wherein the filter is used for filtering out ultraviolet light of a wavelength except for ultraviolet light of a wavelength from 240 to 370 nm.

6. The optical alignment apparatus as claimed in claim 1, wherein the machine table is positioned below the twisted nematic liquid crystal display, and a glass substrate coated with a polyimide liquid is transferred on the machine table.

7. The optical alignment apparatus as claimed in claim 1, wherein a reflective sheet is attached onto an upper surface of the light-guiding plate.

8. The optical alignment apparatus as claimed in claim 1, wherein the alignment light source is a microwave ultraviolet lamp.

9. The optical alignment apparatus as claimed in claim 8, wherein power of the microwave ultraviolet lamp is at least 900 MHz.

10. An optical alignment apparatus, comprising:
a machine table on which a to-be-aligned substrate is conveyed, and above which is provided with:
an alignment light source for emitting alignment light;
a polarizer positioned below the alignment light source so that incident light is transformed into polarized light and is emitted;
a twisted nematic liquid crystal display positioned below the polarizer for controlling a polarization direction of transmitted light, wherein the twisted nematic liquid crystal display includes:
an upper substrate provided with a common electrode layer on a lower surface of the upper substrate;
a lower substrate disposed opposite the upper substrate, wherein an upper surface of the lower substrate is provided with a thin film transistor array and a pixel electrode layer; and
a liquid crystal layer sandwiched between the upper substrate and the lower substrate.

11. The optical alignment apparatus as claimed in claim 10, wherein a lower surface of the upper substrate is provided with an upper alignment film, and an upper surface of the lower substrate is provided with a lower alignment film, an alignment groove on a surface of the upper alignment film is perpendicular to an alignment groove on a surface of the lower alignment film, and the liquid crystal layer is positioned between the upper alignment film and the lower alignment film.

12. The optical alignment apparatus as claimed in claim 11, wherein when no voltage is applied to the twisted nematic liquid crystal display, long axes of liquid crystal molecules in the liquid crystal layer are parallel to the upper alignment film and the lower alignment film, and the liquid crystal molecules in a single pixel are longitudinally distributed and gradually rotate to 90 degrees; and
when a voltage is applied to the twisted nematic liquid crystal display, the long axes of the liquid crystal molecules in the liquid crystal layer are perpendicular to the upper alignment film and the lower alignment film.

13. The optical alignment apparatus as claimed in claim 10, further comprising a filter beneath the alignment light source for filtering out light of a specified wavelength according to actual needs.

14. The optical alignment apparatus as claimed in claim 10, wherein the filter is used for filtering out ultraviolet light of a wavelength except for ultraviolet light of a wavelength from 240 to 370 nm.

15. The optical alignment apparatus as claimed in claim 10, wherein the machine table is positioned below the twisted nematic liquid crystal display, and a glass substrate coated with a polyimide liquid is transferred on the machine table.

16. The optical alignment apparatus as claimed in claim 10, wherein the alignment light source is a microwave ultraviolet lamp.

17. The optical alignment apparatus as claimed in claim 16, wherein power of the microwave ultraviolet lamp is at least 900 MHz.
